(19) United States
(12) Patent Application Publication
(10) Pub. No.: US 2010/0050463 A1
(43) Pub. Date: Mar. 4, 2010

(54) Washer/Dryer

(76) Inventor: Hakan Tatar, Istanbul (TR)

Correspondence Address: VENABLE, CAMPILLO, LOGAN & MEANEY, P.C., 1938 E. OSBORN RD, PHOENIX, AZ, 85016-7234, US

(21) Appl. No.: 12/447,897

(22) PCT Filed: Oct. 30, 2007
(86) PCT No.: PCT/EP2007/061638

§ 371 Date: Apr. 29, 2009

(30) Foreign Application Priority Data
Oct. 31, 2006 (TR) TR2006/06052

(51) Int. Cl. F26B 25/06

(52) U.S. Cl. 34/201

(57) ABSTRACT

The present invention relates to a washer/dryer (1) whereby the processes of loading, unloading the laundry and carrying the unloaded laundry to another place can be performed easily.

The present invention relates to a washer/dryer providing the washed laundry to be easily carried and stored after taking them thereout.

In washer/dryers, particularly in laundry washer/dryers, elements such as a basket, washtub etc. are required for taking the laundry out of the machine and carrying to put away after the washing process is completed. However, these additional elements occupy space when not used and also gather dust making the clean laundry placed therein get dirty in the next usage.

Various implementations have been designed in the technique for solving these problems. In one of the state of the art applications, the United States of America U.S. Pat. No. 6,301,733, a laundry net is described. With this embodiment, it is intended to place the laundry in the net before washing and taking out of the machine after washing in the same net to take to the place for drying.

Another state of the art application is the subject matter of the invention in the French patent no. FR2171084. In this application, a carrier is explained that can be stored in folded form inside the outer door of the washing machine and opened to store and carry the clothes when laundry is to be taken out of the machine.

In another state of the art application, the United States of America U.S. Pat. No. 4,091,548, a laundry basket is described that is mounted on the front door of the dryer such that it can be pivotally opened. It is intended to load the laundry into the machine by placing in this basket and afterwards to unload from this basket. Thus, the amount of laundry to be loaded in the machine is limited by the volume of the said basket.

The object of the present invention is to design a washer/dryer whereby the processes of loading, unloading the laundry and carrying the unloaded laundry to another place can be carried out easily.

The washer/dryer designed to fulfill the object of the present invention is explicated in the claims.

The washer/dryer of the present invention comprises a body, a loading port disposed on the body allowing the laundry to be placed into the washer/dryer, a door covering the loading port in a leak-proof manner, having a convex configuration, extending from the loading port towards the inside of the body and a carrier that can be placed in the convex part of the door. The carrier can be selectively detached from the door and used for unloading the laundry from the washer/dryer and carrying by placing the laundry therein.

In an embodiment of the present invention, the carrier is fitted inside the convex part of the door such that it will stay outside the washer/dryer when the door is closed. In this embodiment, it is possible to access the carrier even when the door is closed.

In another embodiment of the present invention, the carrier is fitted on the outside of the convex part of the door such that it will stay inside the washer/dryer when the door is closed. In this embodiment of the present invention, the carrier is washed together with the laundry in each washing maintaining hygienic usage. Moreover, more laundry can be carried since the depth/width of the carrier fitted on the outside of the convex part is larger.

In an embodiment of the present invention, the carrier comprises at least one handle for allowing the user to grasp the carrier for detaching easily from the door and carrying.

In the preferred embodiment of the present invention, the carrier is transparent. Thus, even when emplaced inside the door, the user can view the interior of the machine and if present, the washed laundry.

The washer/dryer designed to fulfill the object of the present invention is illustrated in the attached figures, where:

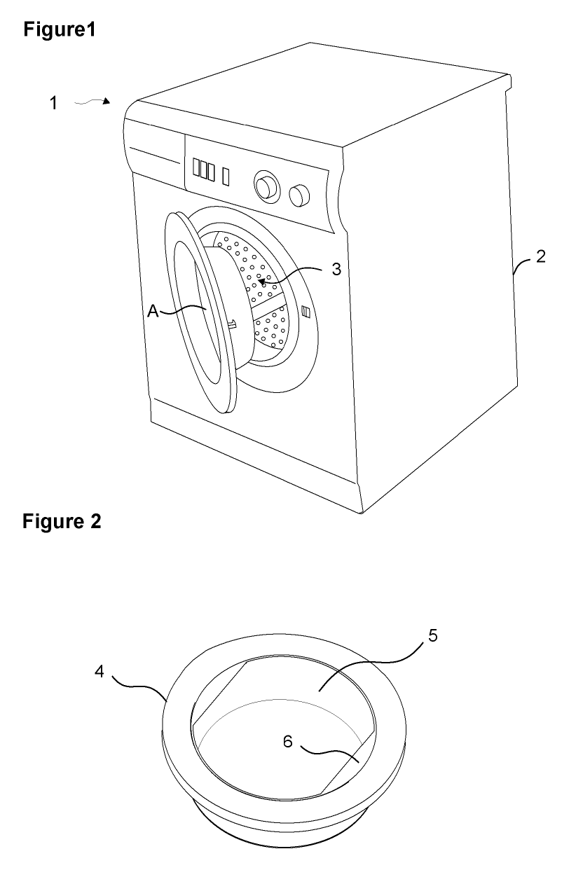

FIG. 1—is the perspective view of an embodiment of the present invention.

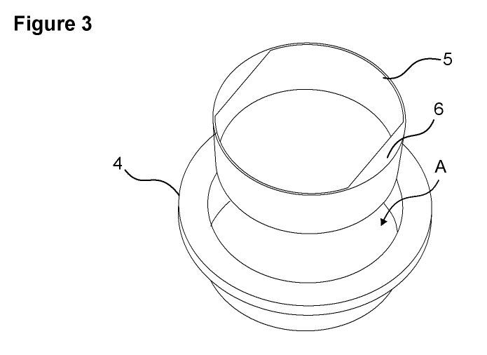

FIG. 2—is the schematic view of an embodiment of the present invention when the carrier is fitted on the door.

FIG. 3—is the schematic view of an embodiment of the present invention, wherein the carrier and the door are shown separately.

The elements illustrated in the figures are numbered as follows:
1. Washer/dryer
2. Body
3. Loading port
4. Door
5. Carrier
6. Handle

The washer/dryer (1) of the present invention comprises a body (2), a loading port (3) disposed on the body (2) allowing to place the laundry therein, a door (4) mounted on the body (2) such that the loading port (3) is covered in openable/closable manner, having a convex configuration, extending from the loading port (3) towards the inside of the body (2) and at least one carrier (5) stored by fitting on the convex face of the door (4), detached when desired for using in unloading and carrying the laundry (FIG. 1).

In an embodiment of the present invention, the carrier (5), when not in use, is fitted inside the convex part (A) of the door (4) that faces the outside when closed. The carrier (5), having a depth/diameter smaller than the convex part (A) of the door (4) allowing to be placed inside the door (4), is shaped like a washtub wherein laundry can be placed, and can be detached from the door (4) when desired to be used in carrying the laundry. In this embodiment, the carrier (5) can also be accessed without opening the door (4).

In another alternative of this embodiment, the carrier (5), when not in use, is fitted on the outside of the convex part (A) of the door (4) that faces inwards when closed. The carrier (5) having a depth/diameter greater than the convex part (A) of the door (4) thus allowing to be placed outside of the door (4), is again shaped like a washtub wherein the laundry can be placed, and can be detached from the door (4) when desired to be used in carrying the laundry. In this embodiment, keeping the carrier (5) inside the washer/dryer (1) when not in use, allows thereof to be cleaned in each washing thus maintaining hygienic usage. Furthermore, more laundry can be carried since the depth/width of the carrier (5) fitted on the outside of the convex part (A) of the door (4) is larger.

In an embodiment of the present invention, the door (4) and the carrier (5) are configured frustonically.

In an embodiment of the present invention, the carrier (5) comprises at least one handle (6) that allows the user to grasp the carrier (5) easily for detaching from the door (4) and carrying (FIG. 2).

In an embodiment of the present invention, the carrier (5) is produced of a transparent material. Thus, when the carrier (5) is fitted on the door (4), viewing the interior of the washer/dryer (1) is not prevented and if present, the washed laundry inside the washer/dryer (1) and the washing process can be monitored.

In another embodiment of the present invention, the carrier (5) is produced of a material having a reflecting/insulating effect, such as teflon. Consequently, when the carrier (5) is fitted on the door (4), the rate of the radiation reaching outside of the washing tub is reduced, for example UV radiation, which is created in the washer/dryer (1) for performing the washing and/or drying processes but not desired to be emitted outside. Moreover, the efficiency of the washer/dryer (1) is increased by providing heat insulation.

With the washer/dryer (1) of the present invention, the requirement for additional elements such as basket, washtub etc. for storing and carrying the laundry after taking out of the washer/dryer (1) is not necessary anymore. The carrier (5), stored by fitting on the door (4) when not used, does not occupy space, and can be used for unloading and carrying the laundry by detaching and placing the laundry therein.

1. A washer/dryer (1) comprising a body (2), a loading port (3) disposed on the body (2) allowing to place the laundry into the washer/dryer (1), a door (4) mounted on the body (2) such that the loading port (3) is covered in openable/closable manner, having a convex configuration, extending from the loading port (3) towards the interior of the body (2) and characterized by at least one carrier (5) stored by fitting on the convex face (A) of the door (4), detached when desired for using in unloading and carrying the laundry.

2. A washer/dryer (1) as in claim 1, characterized by the carrier (5) having a depth/diameter smaller than the convex face (A) of the door (4), stored by fitting inside the convex part (A) of the door (4) that faces outside when the door (4) is closed.

3. A washer/dryer (1) as in claim 1, characterized by the carrier (5) having a depth/diameter greater than the convex face (A) of the door (4), and stored by fitting on the outside of the convex part (A) of the door (4) that faces inwards when the door (4) is closed.

4. A washer/dryer (1) as in any one of the above claims, characterized by the door (4) and the carrier (5) having a frustoconic configuration.

5. A washer/dryer (1) as in any one of the above claims, characterized by the carrier (5) having at least one handle (6) utilized by the user to grasp easily for detaching the carrier (5) from the door (4) and carrying.

6. A washer/dryer (1) as in any one of the above claims, characterized by the carrier (5) that is produced of a transparent material.

7. A washer/dryer (1) as in any one of the above claims, characterized by the carrier (5) that is produced of a material having a reflecting/insulating effect.
